(19) United States
(12) Patent Application Publication
(10) Pub. No.: US 2026/0131343 A1
(43) Pub. Date: May 14, 2026

(54) SPRAYER BOOM MOUNT

(71) Applicant: Tractor Supply Co. of Texas, LP, Brentwood, TN (US)

(72) Inventors: Brian Kennemer, Columbia, TN (US); Ty Rager, Hendersonville, TN (US)

(21) Appl. No.: 18/944,194

(22) Filed: Nov. 12, 2024

(51) Int. Cl. B05B 13/00; B60D 1/48

(52) U.S. Cl. CPC B05B 13/005; B60D 1/48

(57) ABSTRACT

A sprayer boom mount may include a support column configured to be mounted on a vehicle. The sprayer boom mount may include a forward extending latch bar and a boom mounting bracket pivotably attached to the support column and spaced from the forward extending latch bar. A sprayer boom may be mounted to the boom mounting bracket. The boom mounting bracket may be latched in a selected pivotable position by placing a latch pin through aligned holes included in the forward extending latch bar and the boom mounting bracket. Thus, the sprayer boom's spray direction can be adjusted to a preferred position.

### BACKGROUND

### 1. Field of the Disclosure

The present disclosure relates generally to a sprayer boom mount.

### 2. Description of the Prior Art

Various sprayer boom mounts have been developed for supporting sprayer booms from vehicles, each with its own set of advantages and limitations. Conventional sprayer boom mounts typically consist of a support column mounted on the vehicle, a boom mounting bracket pivotably attached to the support column, and a latch mechanism for securing the boom mounting bracket in a desired position. These conventional sprayer boom mounts lack the desired amount of adjustability that the present disclosure offers.

In some existing sprayer boom mounts with multiple adjustment points, the latch mechanism comprises a single latch pin that engages with a corresponding latch bar opening to secure the boom mounting bracket in place. While this design provides a simple and effective means of securing the sprayer boom, it may result in too much force being applied to the latch pins thus causing these conventional sprayer boom mounts to be prone to wear and tear over time, leading to decreased reliability and potential safety concerns during operation.

Additionally, some existing spray boom mounts may include unnecessary and useless adjustability which can be cumbersome and increase complexity which can result in higher manufacturing costs and maintenance requirements.

None of these approaches have provided a comprehensive solution that combines the features described in this disclosure.

### BRIEF SUMMARY

This Brief Summary is provided to introduce a selection of concepts in a simplified form that are further described below in the Detailed Description. This Brief Summary is not intended to identify key features or essential features of the claimed subject matter, nor is it intended to be used as an aid in determining the scope of the claimed subject matter.

The present disclosure is directed to a sprayer boom mount that includes a support column, a boom mounting bracket, and a latch plate. The support column is configured to mount to a vehicle. The boom mounting bracket is configured to accept a sprayer boom.

The support column includes a lower end that is configured to be mounted to the vehicle. The support column also includes a forward extending latch bar that includes at least one latch bar opening that is configured to receive a latch pin.

The boom mounting bracket is pivotably attached to the support column and is spaced from the forward extending latch bar. The boom mounting bracket includes a rearward extending mount for attaching to the sprayer boom and a forward extending arm for connecting to the latch plate.

The latch plate is pivotably attached to the forward extending arm of the boom mounting bracket. The latch plate includes a plurality of latch plate openings configured to align with the at least one latch bar opening and configured to receive the latch pin. By aligning different combinations of the plurality of latch plate openings with the at least one latch bar opening, the boom mounting bracket is able to be placed in a selected pivotable position.

Numerous objects, features and advantages of the present invention will be readily apparent to those skilled in the art upon a review of the following description in conjunction with the accompanying drawings.

### BRIEF DESCRIPTION OF THE DRAWINGS

FIG. 1 is an isometric view of the sprayer boom mount mounted to a vehicle and supporting a sprayer boom.

FIG. 2 is an exploded, isometric view of the sprayer boom mount.

FIG. 3 is an isometric view from the forward side of the sprayer boom mount with certain aspects exploded to show additional detail.

FIG. 4 is an isometric view of the sprayer boom mount.

FIG. 5A is an elevation view of the sprayer boom mount focusing on the upper region including the latch bar.

FIG. 5B is an elevation view of an optional embodiment of the sprayer boom mount focusing on the upper region including the latch bar.

FIG. 6A is an isometric view of the sprayer boom mount focusing on the upper region including the boom mounting bracket with the latch bar hidden to show additional detail.

FIG. 6B is an isometric view of an optional embodiment of the sprayer boom mount focusing on the upper region including the boom mounting bracket with the latch bar hidden to show additional detail.

FIG. 7 is an isometric view from the forward side of an optional embodiment of the sprayer boom mount with the latch bar spaced below the boom mounting bracket.

FIG. 8A is an isometric view of the sprayer boom mount in a selected pivotable position.

FIG. 8B is an isometric view of the sprayer boom mount in a selected pivotable position.

FIG. 8C is an isometric view of the sprayer boom mount in a selected pivotable position.

FIG. 8D is an isometric view of the sprayer boom mount in a selected pivotable position.

FIG. 8E is an isometric view of the sprayer boom mount in a selected pivotable position.

FIG. 8F is an isometric view of the sprayer boom mount in a selected pivotable position.

FIG. 8G is an isometric view of the sprayer boom mount in a selected pivotable position.

### DETAILED DESCRIPTION

Reference will now be made in detail to embodiments of the present disclosure, one or more drawings of which are set forth therein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof. Furthermore, any part of the apparatus of the present disclosure may be made using any applicable manufacturing method, such as, but not limited to 3D printing, injection molding, or the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

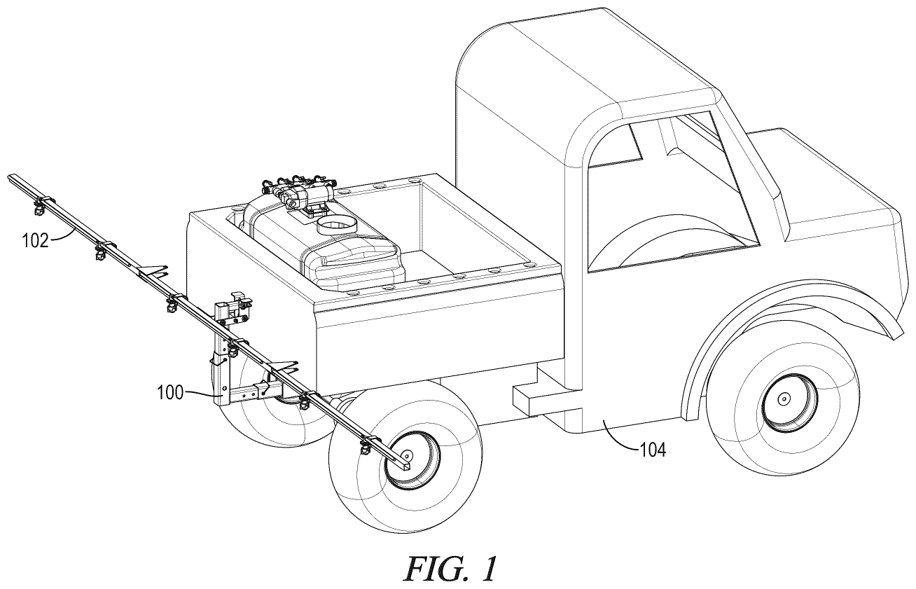

Referring generally to FIGS. 1-8G, a sprayer boom mount 100 is provided. The sprayer boom mount 100 includes a support column 106, a boom mounting bracket 116, and a latch plate 122. The sprayer boom mount 100 may be configured to support a sprayer boom 102 and mount to a vehicle 104.

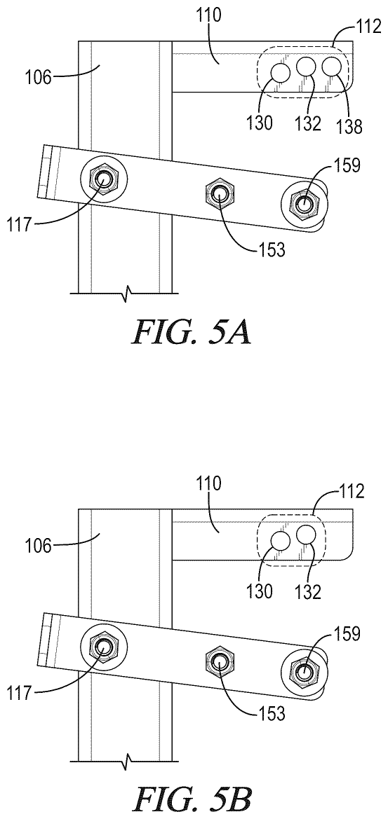

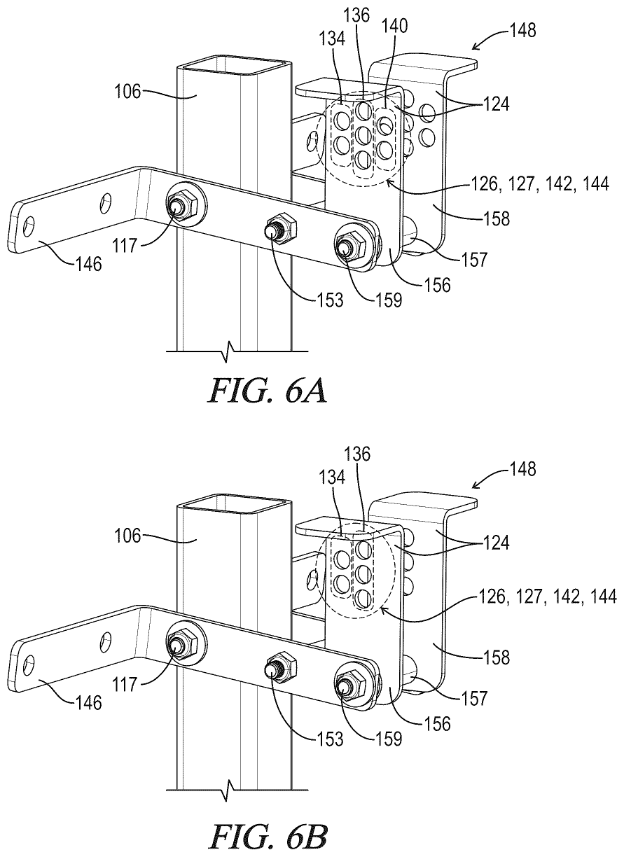

The support column 106 may include a lower end 108 configured to be mounted to the vehicle 104. The support column 106 may also include a forward extending latch bar 110 that may include at least one latch bar opening 112 for receiving a latch pin 114. The forward extending latch bar 110 may include a first latch bar opening 130 and a second latch bar opening 132 spaced front to rear. In some embodiments, the forward extending latch bar 110 may include at least the first latch bar opening 130, the second latch bar opening 132, and a third latch bar opening 138 spaced front to rear. As shown in FIGS. 5A and 5B, in some optional embodiments, at least one of the at least one latch bar openings 112 may be offset vertically relative to the remainder of the at least one latch bar opening 112. The purpose of offsetting one of the at least one latch bar opening 112 may be to ensure that the plurality of latch plate openings 126, as shown in FIGS. 6A and 6B, align properly with the at least one latch bar opening 112.

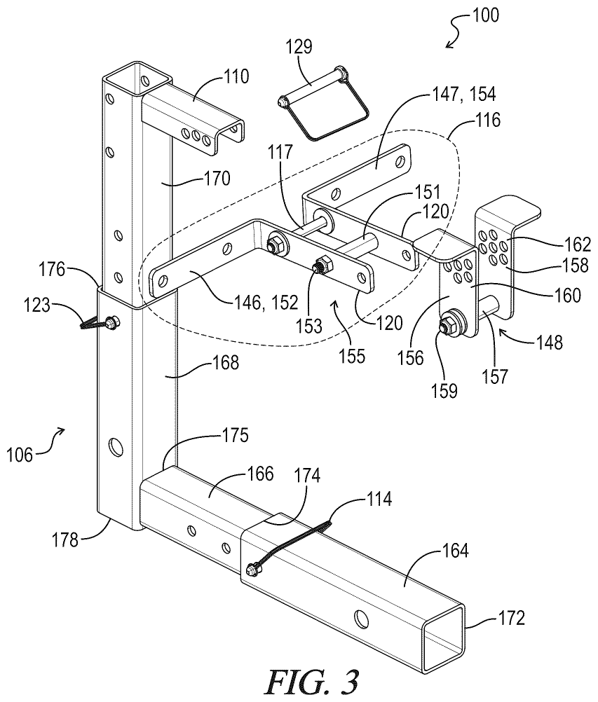

In some optional embodiments, and as shown in FIG. 3, the forward extending latch bar 110 may be a U-shaped channel member.

As shown in FIG. 1, the vehicle 104 may be a lawn tractor, all-terrain vehicle, utility terrain vehicle, or the like.

The lower latch pin 114, the middle latch pin 123, and the upper latch pin 129 may be a variety of different securing mechanisms including without limitation square lock pins, round lock pins, cotter pins, lynch pins, or the like.

The boom mounting bracket 116 may be pivotably attached to the support column 106 and spaced from the forward extending latch bar 110. The boom mounting bracket 116 may also include a rearward extending mount 118 for mounting the sprayer boom 102 and a forward extending arm 120. In some optional embodiments, as shown in FIGS. 3, 6A, and 6B, the boom mounting bracket 116 may be comprised of a first L-shaped bracket 146 and a second L-shaped bracket 146 located on opposing sides of the support column 106 and tied together as a unitary member 155 of the boom mounting bracket 116. In some optional embodiments, the boom mounting bracket 116 may be attached to the support column 106 using a rearward fastener 117.

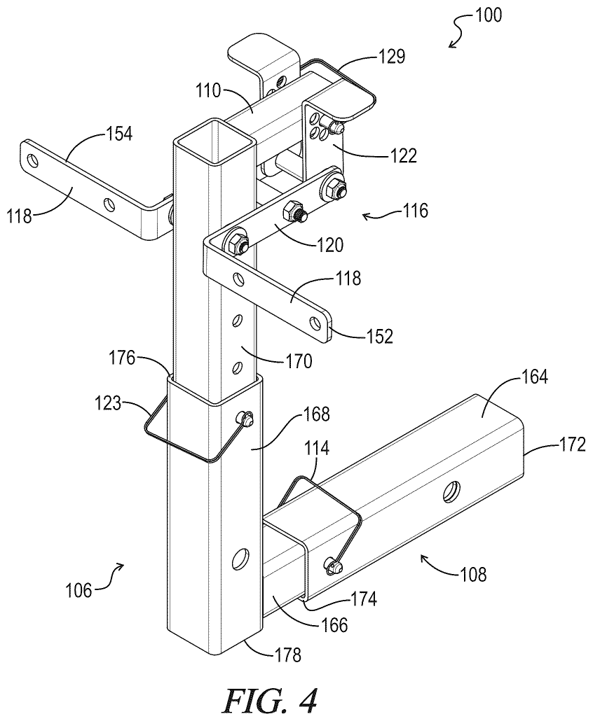

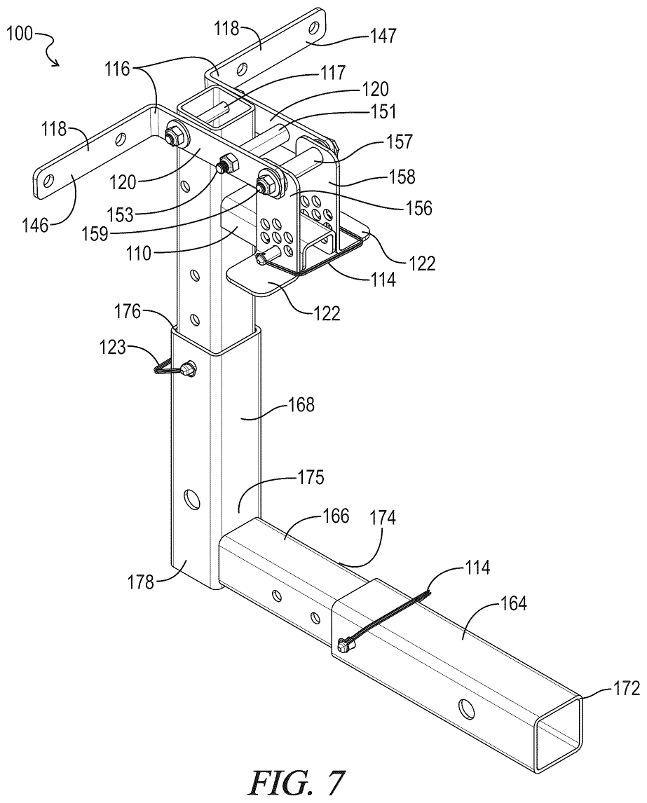

As shown in FIGS. 4, 5A, and 5B, the boom mounting bracket 116 may be pivotably attached to the support column 106 below the forward extending latch bar 110. As shown in FIG. 7, in some optional embodiments, the boom mounting bracket 116 may be pivotably attached to the support column 106 above the forward extending latch bar 110.

As shown in FIG. 3, the boom mounting bracket 116 may include a first mounting bracket member 152 and a second mounting bracket member 154. The first mounting bracket member 152 and the second mounting bracket member 154 may be pivotably attached to opposing sides of the support column 106 and tied together as a unitary member 155 of the boom mounting bracket 116.

In some optional embodiments, the first mounting bracket member 152 and the second mounting bracket member 154 may be separated by a boom mounting bracket separator 151. The boom mounting bracket separator 151 may be a tubular member. The boom mounting bracket separator 151 may be fixed to the first mounting bracket member 152 and the second mounting bracket member 154. The boom mounting bracket separator 151 may be a tubular member configured to receive a middle fastener 153. In this embodiment, the unitary member 155 of the boom mounting bracket 116 is formed by securing the first mounting bracket member 152 to the second mounting bracket member 154 with the middle fastener 153 received through the boom mounting bracket separator 151.

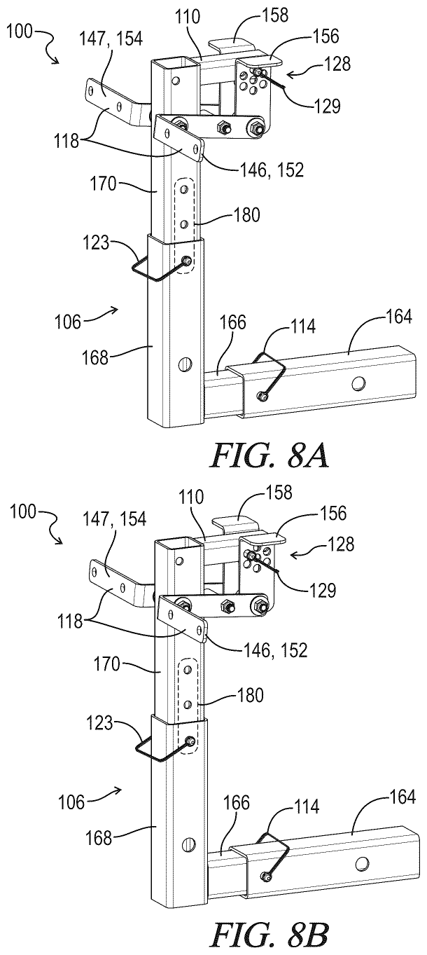

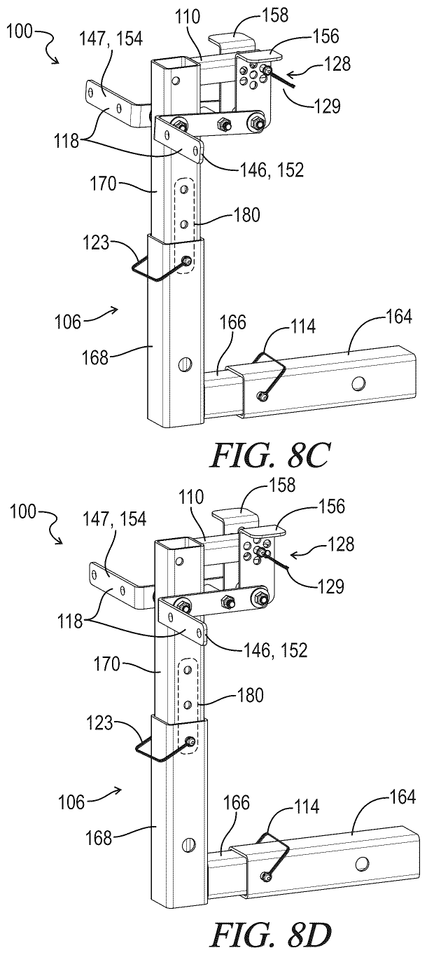

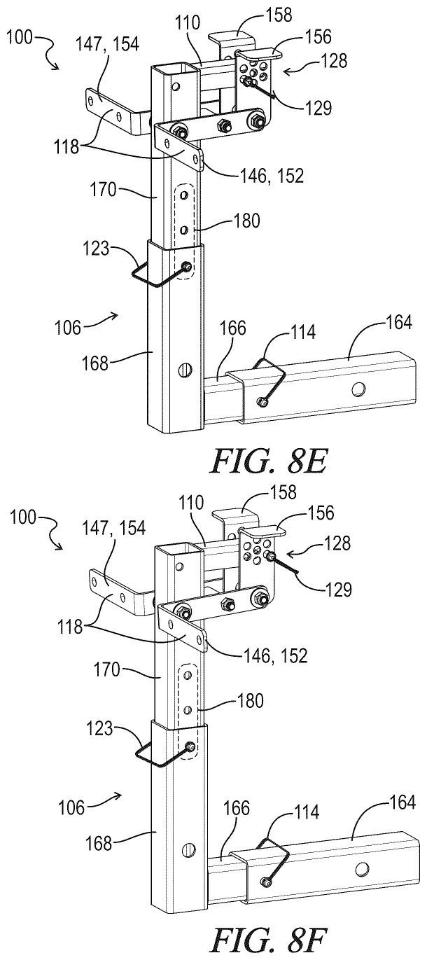

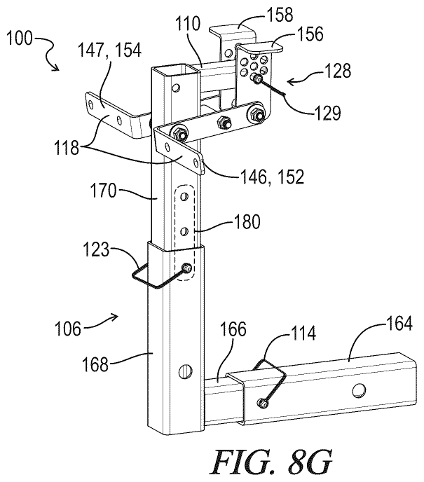

As shown in FIGS. 8A-G, the latch plate 122 may be pivotably attached to the forward extending arm 120 of the boom mounting bracket 116. The latch plate 122 may also have a distal portion 124 which includes a plurality of latch plate openings 126. The plurality of latch plate openings 126 may be arranged such that as the boom mounting bracket 116 is pivoted relative to the support column 106, different ones of the plurality of latch plate openings 126 may be aligned with the at least one latch bar opening 112 so that the boom mounting bracket 116 may be latched in a selected pivotable position 128 by placing the upper latch pin 129 though the aligned holes.

As shown in FIGS. 6B and 5B, the latch plate 122 may include the plurality of latch plate openings 126 arranged in a first column 134 and a second column 136. The plurality of latch plate openings 126 arranged in the first column 134 may be configured to align with the first latch bar opening 130. The plurality of latch plate openings 126 arranged in the second column 136 may be configured to align with the second latch bar opening 132. In some optional embodiments, the latch plate 122 may be comprised of a first latch plate member 156 and a second latch plate member 158 located on opposing sides of the forward extending latch bar forward extending latch bar 110 and be tied together as a unitary member 148 of the latch plate 122.

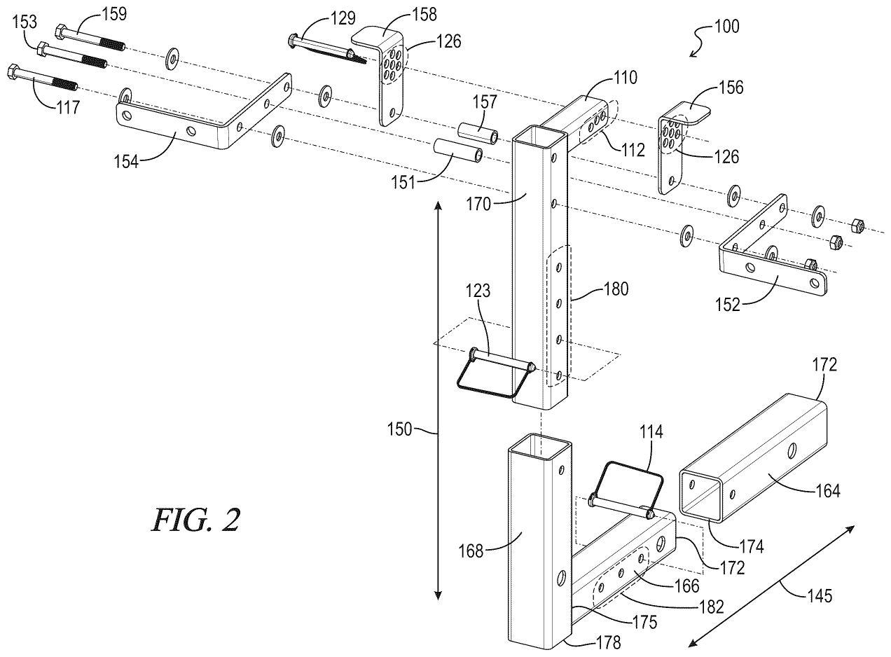

As shown in FIG. 2, the latch plate 122 may include the first latch plate member 156 and the second latch plate member 158. The first latch plate member 156 may be pivotably attached to the first mounting bracket member 152. The second latch plate member 158 may be pivotably attached to the second mounting bracket member 154. The first latch plate member 156 and the second latch plate member 158 may be tied together as a unitary member 148 of the latch plate 122. The first latch plate member 156 and the second latch plate member 158 may be separated by a latch plate separator 157. The latch plate separator 157 may be a tubular member. The latch plate separator 157 may be fixed to the first latch plate member 156 and the second latch plate member 158. The latch plate separator 157 may be a tubular member configured to receive a forward fastener 159. In this embodiment, the unitary member 148 of the latch plate 122 is formed by securing the first latch plate member 156 to the second latch plate member 158 with the forward fastener 159 received through the latch plate separator 157.

As shown in FIGS. 2 and 3, the first latch plate member 156 and the second latch plate member 158 may be L-shaped members. The first latch plate member 156 may have a first distal portion 160. The second latch plate member 158 may have a second distal portion 162. The first distal portion 160 may include the plurality of latch plate openings 126. The second latch plate member 158 may also include the plurality of latch plate openings 126. The at least one latch bar opening 112 may be configured to align with the plurality of latch plate openings 126 of the first distal portion 160. The at least one latch bar opening 112 may also be configured to align with the plurality of latch plate openings 126 of the second distal portion 162.

As shown in FIG. 2, in some optional embodiments, the support column 106 may be telescoping and be configured to adjust a height 150 of the sprayer boom mount 100. The lower end 108 of the support column 108 may be configured to adjust a depth 145 of the sprayer boom mount 100 from the vehicle 104.

As shown in FIGS. 6A and 5A, the latch plate 122 may include the plurality of latch plate openings 126 arranged in the first column 134, the second column 136, and a third column 140. The plurality of latch plate openings 126 arranged in the first column 134 may be configured to align with the first latch bar opening 130. The plurality of latch plate openings 126 arranged in the second column 136 may be configured to align with the second latch bar opening 132. The plurality of latch plate openings 126 arranged in the third column 140 may be configured to align with the third latch bar opening 138.

As shown in FIG. 6A, in some embodiments where the latch plate 122 includes the plurality of latch plate openings 126 arranged in a pattern 142 comprising three columns 127, the three columns 127 may be characterized by two columns 127 of an even number of the plurality of latch plate openings 126 spaced equally from each other and flanking a single column 127 of an odd number of the plurality of latch plate openings 126 spaced equally from each other to form a hexagonal shape 144.

As shown in FIG. 6B, in some optional embodiments, the latch plate 122 may include the plurality of latch plate openings 126 arranged in the pattern 142 comprising two columns 127. In this embodiment, the forward extending latch bar 110 may include the first latch bar opening 130 and the second latch bar opening 132. The plurality of latch plate openings 126 arranged in the first column 134 may be configured to align with the first latch bar opening 130. The plurality of latch plate openings 126 arranged in the second column 136 may be configured to align with the second latch bar opening 132. In this optional embodiment, the pattern 142 may be characterized by the two columns 127 wherein the first column 134 includes an even number of the plurality of latch plate openings 126 and the second column 136 includes an odd number of the plurality of latch plate openings 126.

As shown in FIGS. 8A-G, in some embodiments, the pattern 142 may be configured to provide sequential steps when one of the plurality of latch plate openings 126 aligns with one of the at least one latch bar openings 112. Each sequential step may preferably provide 2.4° of movement of the boom mounting bracket 116 relative to the support column 106. However, it is contemplated that this quantity may be within the range of 2°-4°. The total range of motion for the sequential steps may preferably be 15° relative to the support column 106. However, it is contemplated that this quantity may be within the range of 10°-20°.

FIGS. 8A-G provide optional embodiments of a sequence of selected pivotable positions 128 of the boom mounting bracket 116. In FIG. 8A, the boom mounting bracket 116 is in the selected pivotable position 128 wherein the boom mounting bracket 116 is tilted upward to the highest limit within the range of 10°-20° relative to the support column 106. In FIG. 8B, the boom mounting bracket 116 is tilted approximately 2.4° lower than the highest limit within the range of 10°-20°. In FIG. 8C, the boom mounting bracket 116 is tilted approximately 4.8° lower than the highest limit within the range of 10°-20°. In FIG. 8D, the boom mounting bracket 116 is tilted approximately 7.2° lower than the highest limit within the range of 10°-20°. In FIG. 8E, the boom mounting bracket 116 is tilted approximately 9.6° lower than the highest limit within the range of 10°-20°. In FIG. 8F, the boom mounting bracket 116 is tilted approximately 12° lower than the highest limit within the range of 10°-20°. In FIG. 8G, the boom mounting bracket 116 is tilted approximately 14.4° lower than the highest limit within the range of 10°-20°.

As shown in FIG. 2, in some optional embodiments, the sprayer boom mount 100 may be comprised of an outer lower member 164, an inner lower member 166, an outer upper member 168, and an inner upper member 170. The outer lower member 164 may be a square tubular member configured to mount to the vehicle 104. The inner lower member 166 may be a square tubular member configured to slide into the outer lower member 164. The outer upper member 168 may be a square tubular member configured to support the sprayer boom mount 100. A lower end 178 of the outer upper member 168 may be fixed to a rearward end 175 of the inner lower member 166 such that the outer upper member 168 is perpendicular relative to the inner lower member 166. The outer lower member 164 and the inner lower member 166 may each contain a plurality of lower member openings 182. The outer upper member 168 and the inner upper member 170 may each contain a plurality of upper member openings 180. The plurality of lower member openings 182 of the outer lower member 164 may be configured to align with the plurality of lower member openings 182 of the inner lower member 166. The plurality of upper member openings 182 of the outer upper member 168 may be configured to align with the plurality of upper member openings 182 of the outer inner member 170. The aligned holes of the outer lower member 164 and the inner lower member 166 may be secured with the lower latch pin 114. The aligned holes of the outer upper member 168 and the inner upper member 170 may be secured with the middle latch pin 123. The plurality of upper member openings 180 may be configured to adjust the height of the support column 106. The plurality of lower member openings 182 may be configured to adjust the depth of the support column 106 relative to the vehicle 104.

The pattern 142 of the plurality of latch plate openings 126 is an improvement over the prior art. The hexagonal shape 144 of the pattern 142 of the plurality of latch plate openings 126 maximizes the plurality of latch plate openings 126 in a relatively small space on the latch plates 122 which allows for a large range of movement for the boom mounting bracket 116 while taking up the least amount of space. The hexagonal shape 144 of the pattern 142 of the plurality of latch plate openings 126 ensures consistent spacing between each of the plurality of latch plate openings 126 which optimizes material usage and cuts down on manufacturing time and complexity. The hexagonal shape 144 of the pattern 142 of the plurality of latch plate openings 126 is also versatile in that it easily can be scaled and adapted to various applications and spacing constraints. The hexagonal shape 144 of the pattern 142 of the plurality of latch plate openings 126 is also easy to use. The configuration of the sprayer boom 102 mounted on the boom mounting bracket 116 decreases the amount of force required to adjust the boom mounting bracket 116 using the plurality of latch plate openings 126 compared to the prior art because the only weight to account for is that of the sprayer boom 102 whereas some of the prior art includes additional members that increase the weight and therefore force required to adjust the boom mounting bracket 116.

Thus, it is seen that the device of the present disclosure readily achieves the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A sprayer boom mount for supporting a sprayer boom from a vehicle, the sprayer boom mount comprising:
a support column including a lower end configured to be mounted on the vehicle, and including a forward extending latch bar, the forward extending latch bar including at least one latch bar opening for receiving a latch pin;
a boom mounting bracket pivotably attached to the support column and spaced from the forward extending latch bar, the boom mounting bracket including a rearward extending mount for mounting the sprayer boom and a forward extending arm; and
a latch plate pivotably attached to the forward extending arm of the boom mounting bracket, the latch plate having a distal portion with a plurality of latch plate openings arranged such that as the boom mounting bracket is pivoted relative to the support column, different ones of the plurality of latch plate openings can be aligned with the at least one latch bar opening so that the boom mounting bracket can be latched in a selected pivotable position by placing the latch pin through the aligned holes.

2. The sprayer boom mount of claim 1, wherein the forward extending latch bar comprises at least a first latch bar opening and a second latch bar opening spaced front to rear.

3. The sprayer boom mount of claim 2, wherein the latch plate comprises the plurality of latch plate openings arranged in a first column and a second column, and the plurality of latch plate openings arranged in the first column is configured to be aligned with the first latch bar opening and the plurality of latch plate openings arranged in the second column is configured to be aligned with the second latch bar opening.

4. The sprayer boom mount of claim 1, wherein the forward extending latch bar comprises at least a first latch bar opening, a second latch bar opening, and a third latch bar opening spaced front to rear.

5. The sprayer boom mount of claim 4, wherein the latch plate comprises the plurality of latch plate openings arranged in a first column, a second column, and a third column, the plurality of latch plate openings arranged in the first column configured to be aligned with the first latch bar opening, the plurality of latch plate openings arranged in the second column configured to be aligned with the second latch bar opening, and the plurality of latch plate openings arranged in the third column configured to be aligned with the third latch bar opening.

6. The sprayer boom mount of claim 1, wherein the latch plate comprises the plurality of latch plate openings arranged in a pattern comprising three columns wherein the three columns are characterized by two columns of an even number of latch plate openings spaced equally from each other flanking a single column of an odd number of latch plate openings spaced equally from each other to form a hexagonal shape.

7. The sprayer boom mount of claim 6, wherein the pattern is configured to provide sequential steps when one of the plurality of latch plate openings aligns with one of the at least one latch bar openings, each sequential step providing 2-4 degrees of movement of the boom mounting bracket relative to the support column with a total range of 10-20 degrees of movement of the boom mounting bracket relative to the support column.

8. The sprayer boom mount of claim 1, wherein at least one of the at least one latch bar openings is offset vertically relative to the remainder of the at least one latch bar openings.

9. The sprayer boom mount of claim 1, wherein the boom mounting bracket is comprised of two L-shaped brackets located on opposing sides of the support column and tied together as a unitary member.

10. The sprayer boom mount of claim 1, wherein the latch plate is comprised of two latch plates located on opposing sides of the forward extending latch bar and tied together as a unitary member.

11. The sprayer boom mount of claim 1, wherein the support column is telescoping and configured to adjust a height of the sprayer boom mount.

12. The sprayer boom mount of claim 1, wherein the boom mounting bracket is pivotably attached to the support column below the forward extending latch bar.

13. The sprayer boom mount of claim 1, wherein the boom mounting bracket is pivotably attached to the support column above the forward extending latch bar.

14. A sprayer boom mount for supporting a sprayer boom from a vehicle, the sprayer boom mount comprising:
a support column including a lower end configured to be mounted on the vehicle, and including a forward extending latch bar, the forward extending latch bar including at least one latch bar opening for receiving a latch pin;
a boom mounting bracket including a first mounting bracket member and a second mounting bracket member, the first mounting bracket member and the second mounting bracket member pivotably attached to opposing sides of the support column and tied together as a unitary member;
a latch plate including a first latch plate member and a second latch plate member, the first latch plate member pivotably attached to the first mounting bracket member and the second latch plate member pivotably attached to the second mounting bracket member, the first latch plate member and the second latch plate member tied together as a unitary member;
the first latch plate member having a first distal portion and the second latch plate member having a second distal portion, the first distal portion and the second distal portion each having a plurality of latch plate openings, at least one of the plurality of latch plate openings configured to align with the at least one latch bar opening; and
the plurality of latch plate openings are arranged such that as the boom mounting bracket is pivoted relative to the support column, different ones of the plurality of latch plate openings can be aligned with the at least one latch bar opening so that the boom mounting bracket can be latched in a selected pivotable position by placing the latch pin through the aligned holes.

15. The sprayer boom mount of claim 14, wherein the support column is telescoping and configured to adjust a height of the sprayer boom mount.

16. The sprayer boom mount of claim 14, wherein the latch plate comprises the plurality of latch plate openings arranged in a pattern comprising three columns wherein the three columns are characterized by two columns of an even number of latch plate openings spaced equally of each other flanking a single column of an odd number of late plate openings spaced equally from each other to form a hexagonal shape.

17. The sprayer boom mount of claim 16, wherein the pattern is configured to provide sequential steps when one of the plurality of latch plate openings aligns with one of the at least one latch bar openings, each sequential step providing 2-4 degrees of movement of the boom mounting bracket relative to the support column within a total range of 10-20 degrees of movement of the mounting bracket relative to the support column.

18. The sprayer boom mount of claim 16, wherein at least one of the plurality of latch plate openings is offset vertically relative to the remainder of the plurality of latch plate openings.

19. The sprayer boom mount of claim 14, wherein the boom mounting bracket is pivotably attached to the support column below the forward extending latch bar.

20. The sprayer boom mount of claim 14, wherein the boom mounting bracket is pivotably attached to the support column above the forward extending latch bar.
